(19) United States
(12) Patent Application Publication
(10) Pub. No.: US 2006/0124426 A1
(43) Pub. Date: Jun. 15, 2006

(54) Viscous torsional vibration damper comprising cooling channels

(75) Inventors: Wolfgang Kiener, Berlin (DE); Joerg Sandig, Berlin (DE)

Correspondence Address: CROWELL & MORING LLP;INTELLECTUAL PROPERTY GROUP, P.O. BOX 14300, WASHINGTON, DC, 20044-4300, US

(73) Assignee: Hasse & Wrede GmbH, Berlin (DE)

(21) Appl. No.: 10/532,488

(22) PCT Filed: Oct. 16, 2003
(86) PCT No.: PCT/EP03/11492

§ 371 Date: Jan. 9, 2006

(30) Foreign Application Priority Data
Oct. 23, 2002 (DE) 10249555.6
Jan. 17, 2003 (DE) 10301707.0

(51) Int. Cl. F16D 31/00

(52) U.S. Cl. 192/58.4

(57) ABSTRACT

The invention relates to a viscous torsional vibration damper comprising a damping housing (1) that surrounds an annular working chamber (7) and can be connected to a machine part that is to be damped. In order to improve the dissipation of heat from the interior of the damper, a fan plate (15) is mounted on at least one flat face of the damper to conduct heat. A plurality of hollow cylindrical cooling channels (17, 18) projects from the plane of the fan plate, said channels creating intense turbulence in the air that is entrained by the rotation, thus intensifying the transfer of heat.

### BACKGROUND AND SUMMARY OF THE INVENTION

The invention relates to a viscous torsional vibration damper including an annular housing which can be non-rotatably connected with a machine shaft, particularly an engine shaft, the housing surrounding a working chamber for receiving a flywheel, and the working chamber being filled with a viscous damping medium, at least one of the two faces of the torsional vibration damper carrying a fan plate with cooling channels. Such a viscous torsional vibration damper is disclosed in German Patent document DE 197 29 489 A1.

The viscous torsional vibration damper, in the following abbreviated as “visco damper”, is normally flanged to the opposite side with respect to the force of diesel engine crankshafts. It has the purpose of reducing the torsional vibration amplitudes of the crankshaft. As a result of the oscillating shearing of the silicone oil damping medium in the interior of the damper, vibration energy is converted to heat which has to be dissipated by convection to the ambient air or to another cooling medium.

The efficiency of a visco damper depends, among other things, on the heat transfer between the damping medium, the walls of the damper housing and the surrounding cooling medium. An exceeding of the maximally permissible operating temperature leads to a “boiling-off” of the silicone oil and, therefore, to a non-reversible loss of quality. It is therefore necessary to optimize the above-mentioned heat transfer as much as possible, for example, by a forced convection at the surface of the damper housing.

For achieving this object, the air surrounding the visco damper is turbulently swirled by means of suitable devices and thus the heat transfer on the damper surface is improved.

The arrangement of fan blades on the face of the visco damper known from German Patent document DE 42 05 764 A1 had this goal. In the case of the visco damper described there, the damper housing is equipped with fan plates on both end faces. On these fan plates, a plurality of fan blades are cut out in a U-shape and put on edge. The blades are situated in planes parallel to the axis and are disposed at a constant angle with respect to one another. The fan blades, consisting of a very heat-conducting material, enlarge the ventilated surface of the damper and thus ensure an improved heat dissipation during the operation. Furthermore, the fan plates are fastened by way of a heat-conducting adhesive on the assigned end face of the damper housing.

However, it is difficult to automate the gluing process of visco dampers equipped in this manner; and special care has to be taken during the shipment, the mounting on the engine and also in the operation, so that the projecting fan blades will not be damaged. In addition, there is always the risk that a fitter may be injured by the sharp-edged sheet metal parts.

British Patent document GB 650 891 also relates to the heat transfer on visco dampers. The damper described here has projecting blades oriented in a ray-shaped or curved manner, which are covered by a co-rotating sheet metal cap. This solution has the disadvantages of the space requirement and of the technological difficulty of fastening the cap on the blades at the lowest expenditures.

German Patent document DE 197 29 489 A1 relates to the convection cooling of visco dampers. Here, fan plates with radially extending, tube-shaped cooling ducts on the two end faces of the damper housing guide the air entrained as a result of the rotation. The ducts extend along the entire width of the fan plate. In a desired manner they are situated close to one another on its inner radius but necessarily diverge toward the outer radius, although the densest heat flow would have to be dissipated there. Because of the considerable duct length, the cooling air in the tubes has a predominantly laminar flow; however, a turbulent flow would be more efficient thermally. The ducts extending from radially inside to radially outside have the effect that the uncombined fan plate becomes unstable; it warps and is difficult to handle. It is also a disadvantage that these fan plates are connected with the damper end faces by spot welding, which can be automated only by means of program-controlled robots.

Based on the above, it is an object of the invention to provide a viscous torsional vibration damper of the above-mentioned type whose heat dissipation as well as manufacturing, handling, and dimensional stability are improved.

An important advantage of the invention is the arrangement of cooling channels on at least two concentric circles of the fan plate. The air flowing past in the radial direction during the operation of the viscous torsional vibration damper first comes in contact with the radially inner cooling channels and then with the radially outer cooling channels. In both “contact cases”, a heat transfer takes place from the cooling channels to the air. As a result of the arrangement of the cooling channels in two or more rows, because of the radial spacing of the cooling channels, an additional swirling of the air takes place and prevents the laminar cooling air flow which is less favorable for a high heat transfer. Specifically, on highly stressed dampers, an improved convection and heat transmission can therefore be achieved.

A further optimization of the heat transfer can be achieved by the shaping parameter of the cooling channels. As a result of the variation of the geometric dimensions of the radially outer cooling channels with respect to those of the radially inner cooling channels, the turbulence of the air flow can be locally influenced, which again results in an improved convection and heat transmission. It may definitely also be desirable to vary the thermal stressing by way of the radial dimension of the viscous torsional vibration damper in order to influence the damping behavior.

An advantageous construction parameter is the ratio c between the radial length l and the width b of the cooling channels. As soon as the ratio cₐ of the radially outer cooling channels is greater than the ratio cᵢ of the radially inner cooling channels, the cooling behavior can be locally adapted and a turbulence formation can be promoted already in the radially inner area. Favorable values for c are between 3.5 and 1.

As an alternative or in addition to the above-mentioned construction parameters, the geometry of the cooling channels should be selected such that the cross-sectional surface Qₐ of the radially outer cooling channels is smaller than the cross-sectional surface Qᵢ of the radially inner cooling channels. As a result, the cooling behavior can be locally adapted and a turbulence formation can be promoted.

A comparable effect is obtained when the radially inner cooling channels are wider than the radially outer cooling channels.

The angular distance α is a construction parameter for influencing the local cooling behavior, which can be varied at low expenditures with respect to manufacturing. Generally, the angular distance αₐ between adjacent cooling channels situated radially on the outside is smaller than the angular distance αᵢ between the cooling channels situated radially on the inside. The angular distance αₐ between the radially outer cooling channels preferably amounts to from 3° to 7°; for the radially inner cooling channels, αᵢ preferably amounts to from 5° to 15°.

An orientation of the cooling channels which is sloped with respect to the radial line is suitable when, while taking into account the shaft rotating direction, a cooling air throughput is to be achieved that is as high as possible. Angles of slope β of up to 30° are favorable.

The cooling channels are preferably situated on different radial lines so that the offset arrangement of the cooling channels of different graduated circles intimately swirls the entrained cooling air, which achieves the best-possible heat transfer.

The cooling channels preferably represent integral components of a fan plate which is easy to handle. They are worked out of the material of the plate by metal working. In a constructionally simple and cost-effective fashion, the fan plate is made of thin metal sheet of good thermal conductivity, the cooling channels being notched on two—relative to the axis of rotation of the damper—tangential sides and being deep-drawn in an arched manner from the plane of the fan plate. The longitudinal dimension of each cooling channel is therefore always smaller than the width of the plate. The lining-up of the arching cooling channels over the entire circular-ring surface of the fan plate provides the visual impression of a wave movement.

Radially outside and inside each row of arched cooling channels, plane circular-ring parts of the fan plate remain, which provide it with dimensional stability and evenness and are suitable for the arrangement of circular beam welding seams. Such welding seams are produced in an automated process and in a single mounting, and therefore in a particularly economical manner. Furthermore, they establish an intimate, very heat-conductive connection between the fan plate and the damper housing.

Because of the softly rounded arching of each individual cooling channel, the risk of injury is largely excluded. In addition, the curved blades are so dimensionally stable that several dampers with applied fan plates can be stacked, stored and shipped in a space-saving manner.

An advantage with respect to manufacturing consists of the fact that the fan plate is either produced in a single operation which comprises stamping, notching and deep-drawing; or, in the case of smaller piece numbers, first the plane circular sheet metal blank can be stamped out, into which then limited segments of cooling channels are then placed by iterative step-by-step action. Economical intermediate stages of the two methods are also conceivable.

### BRIEF DESCRIPTION OF THE DRAWINGS

In the following, the invention will be explained by means of an embodiment with reference to the attached drawingS.

FIG. 1 is a halved sectional view of the torsional vibration damper according to the invention;

FIG. 2 is a view of the fan plate according to FIG. 3 in an axonometric representation;

FIG. 3 is a view of the fan plate with two rows of cooling channels;

FIG. 4 is a view corresponding to the direction of the arrow “A” in FIG. 3;

FIG. 5 is a cross-sectional view of a single cooling channel;

FIG. 6 is a partial view of a fan plate according to FIG. 3 with angularly offset rows of channels; and

FIG. 7 is a partial view of a fan plate with sloped outer cooling channels.

### DETAILED DESCRIPTION OF THE DRAWINGS

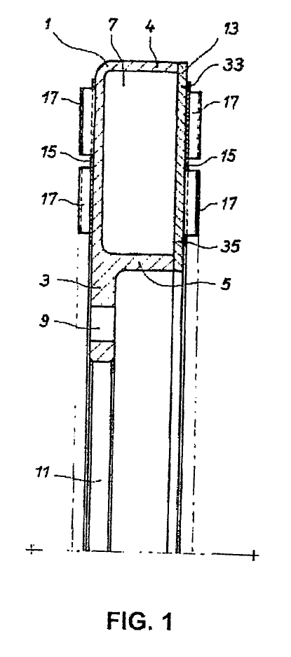

FIG. 1 of the drawing is a halved sectional view of a viscous torsional vibration damper according to the invention, which comprises a damper housing 1 with the radially interior fastening flange 3. The damper housing 1 is produced of steel plate or another suitable material and, by means of its outer shell 4 and the inner shell 5, surrounds the annular working chamber 7, in which a secondary mass (fly wheel not shown) disposed in a sliding manner and the viscous damping medium are situated.

The fastening flange 3 has fastening bores 9 arranged in a distributed manner on a common diameter, for receiving screws by which the visco damper is screwed or otherwise connected to a rotating machine part, such as a crankshaft to be damped. The center opening 11 accommodates the centering attachment or the like of the machine part to be damped. In principle, other force-locking or form-locking connections of the damper housing with the shaft to be damped are also contemplated.

The side of the working chamber 7 of the visco damper, which is on the right in the sectional view of FIG. 1, is closed by the lid 13. The lid 13 is produced from a stamped-out or otherwise shaped circular sheet metal blank. A fan plate 15 is fastened to at least one of the end faces of the damper housing—in the embodiment, to both its faces. The fan plates 15 are made of circular blanks of thin sheet metal and are each provided with a plurality of cooling channels 17, 18 which, with their longitudinal channel axis, are situated on radial lines of the damper housing 1.

With respect to the visco damper, the cooling channels 17, 18 are situated on two different concentric graduated circles. The radial dimension of the fan plates 15 and of the cooling channels 17, 18 respectively is selected such that the cooling channels 17, 18 are situated in the flank area of the flywheel (not shown) and are separated from the working chamber by the wall of the damper housing 1 or of the lid 13. This permits a heat transmission from the damping medium to the cooling channels 17, 18 along the shortest path.

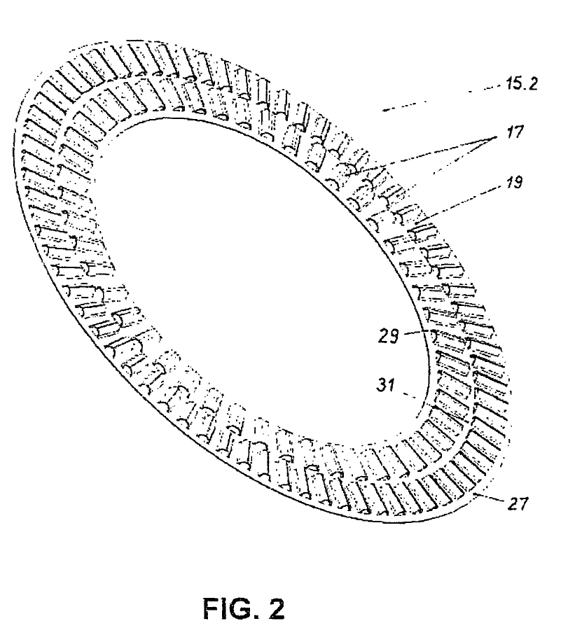

The characteristic wave structure of the fan plate 15 is illustrated in FIG. 2 by means of the axonometric representation.

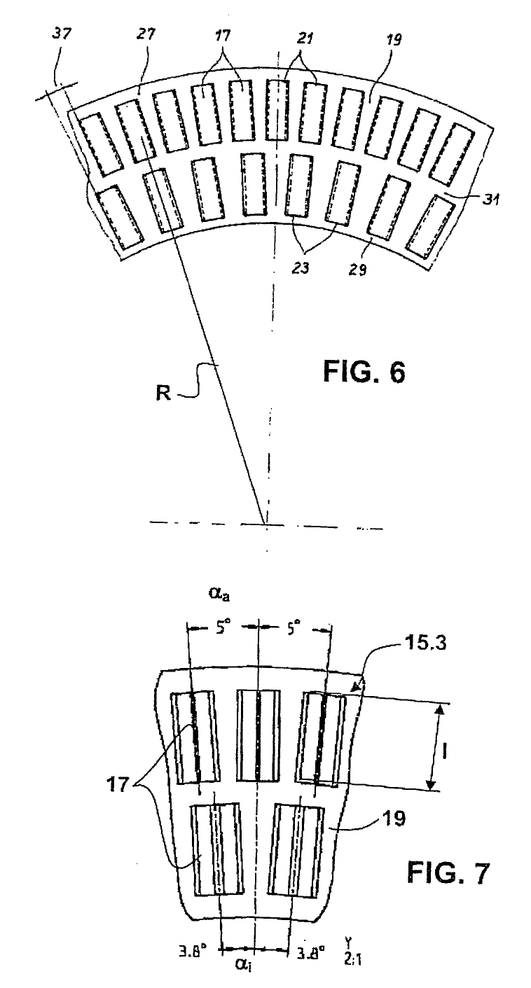

In the case of the fan plate 15 according to the invention illustrated in FIG. 6 as a partial top view, two concentric rows of regularly distributed cooling channels 17, 18 are shown. The inner channels 18 and the outer channels 17 are offset with respect to one another by several angular degrees, so that the cooling air delivered from the radial interior or the radial exterior is swirled together in the best possible manner and a maximal cooling effect is achieved. The cooling channels 17, 18 are radially oriented; the fan plate is therefore equally well suitable for both rotating directions. In special usages, it may be expedient to provide the cooling channels 17, 18 with an optimized shaping with a view to a preferred rotating direction. Instead of the regular division, other arrangements of the cooling channels are also contemplated, such as in segmented groups which are spaced away from one another by several angular degrees.

The cooling channels are worked out of the material of the circular sheet metal blank 19. In this case, the stamped-out circular blank is notched at the points marked by numbers 21,23. In the subsequent deep-drawing process, the cooling channels are deep-drawn individually or in groups and are arched. If the required cutting and stamping tools are available, the stamping, notching and deep-drawing operations can be combined particularly economically.

Since the cooling channels in their longitudinal dimension extend only over a portion of the fan plate width, the undeformed, plane circular rings 27, 29 are retained radially outside and inside of the channels, which circular rings 27, 29 can be used as paths for the circular beam welding seams 33, 35. Such welding seams are outlined in the sectional view of FIG. 1.

The outer and inner circular ring 27, 29 are joined by the central circular ring 31 between the two channel rows. If required, a beam welding seam can be placed here also as an additional linkage of the fan plate.

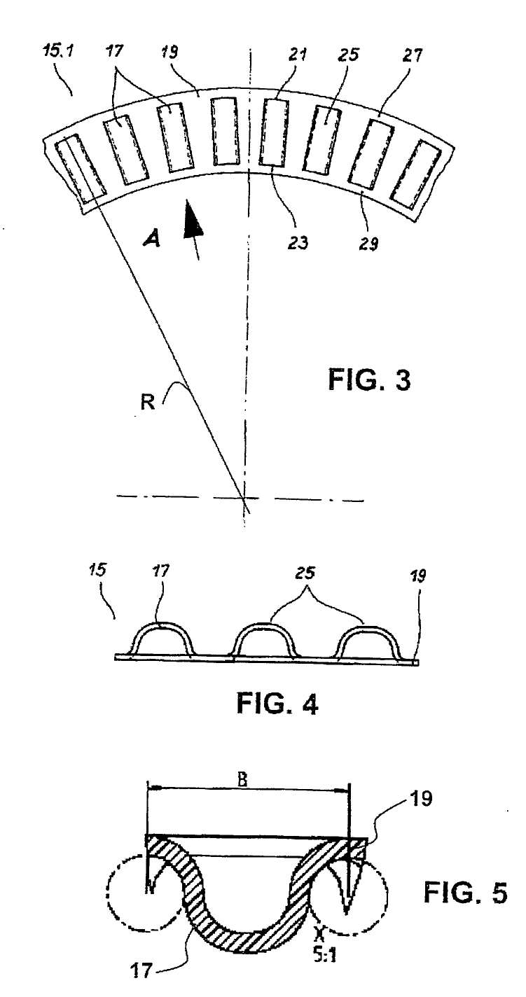

The partial view of FIG. 4 shows how the drawn-through cooling channels 17 project over the plane circular sheet metal blank 19. The observer's view (arrow “A” in FIG. 3) here follows the cooling air flow which is guided through the channel type archings 25 from the radial interior to the radial exterior. Between the arched cooling channels 17, the circular sheet metal blank 19 rests on the damper housing 1 or on the lid 13 and thus provides an optimal heat transfer.

As illustrated in FIG. 5, the width b of the cooling channels is determined by the sweeps r which the cooling channels 17, 18 have in the transition to the circular sheet metal blank 19. Apart from deviations caused by manufacturing, the cross-sectional surface Qᵢ, Qₐ of the cooling channels is constant.

The fan plate illustrated in FIG. 6 has an angular distance αᵢ=3.8° in the case of the radially inner cooling channels 18. The angular distance between the radially outer cooling channels 17 amounts to αₐ=5.0°. The ratio between the radial length l and the width b of the cooling channels is at c=2.

In the case of the fan plate of FIG. 7, the radially outer cooling channels are arranged to be sloped with respect to their respective radial lines by the angle of slope β.

The expenditures for the heat-related optimization of the visco damper are relatively low. The above-described arrangement has the advantage that it does not influence the normal manufacturing process of the dampers themselves but is carried out only after its conclusion. Dampers which have already been produced and may already be in use can be retrofitted by means of the fan plates according to the invention.

### Table of Reference Symbols

1 damper housing
3 fastening flange
4 outer shell
5 inner shell
7 working chamber
9 fastening bore
11 center opening
13 lid
15 fan plate
17 inner cooling channel
18 outer cooling channel
19 circular sheet metal blank
21 outer notch
23 inner notch
25 channel circle, row of several cooling channels
27 outer circular ring
29 inner circular ring
31 central circular ring
33 outer beam welding seam
35 inner beam welding seam
37 angular offset
b width
c ratio
l length
R radial
r sweep
Q, Qₐ, Q₁ cross-sectional surface
α, αₐ, αᵢ angular distance
β angle of slope

1.-14. (canceled)

15. A viscous torsional vibration damper, having two faces comprising:
an annular damper housing, which can be non-rotatably connected with a machine shaft;
said damper housing surrounding a working chamber for receiving a flywheel; and
said working chamber being filled with a viscous damping medium;
wherein at least one of the two faces of the torsional vibration damper carries a fan plate with radially inner and radially outer cooling channels, the cooling channels being arranged on at least two concentric graduated circles of the fan plate; and
further wherein the radially inner cooling channels have different geometrical dimensions than the radially outer cooling channels.

16. The viscous torsional vibration damper according to claim 15, wherein a ratio cₐ between a radial length l and a width b of the radially outer cooling channels is greater than a ratio cᵢ of the radially inner cooling channels.

17. The viscous torsional vibration damper according to claim 16, wherein the ratios cₐ, cᵢ are between 3.5 and 1.

18. The viscous torsional vibration damper according to claim 15, wherein a cross-sectional surface Qₐ of the radially outer cooling channels is smaller than a cross-sectional surface Qᵢ of the radially inner cooling channels.

19. The viscous torsional vibration damper according to claim 15, wherein the radially inner cooling channels are wider than the radially outer cooling channels.

20. The viscous torsional vibration damper according to claim 15 wherein an angular distance αₐ between adjacent radially outer cooling channels is smaller than an angular distance αᵢ of the radially inner cooling channels.

21. The viscous torsional vibration damper according to claim 20, the angular distance αₐ between adjacent radially outer cooling channels is between 3° and 7°.

22. The viscous torsional vibration damper according to claim 20, wherein the angular distance αᵢ between adjacent radially inner cooling channels is between 5° and 15°.

23. The viscous torsional vibration damper according to claim 21, wherein the angular distance αᵢ between adjacent radially inner cooling channels is between 5° and 15°.

24. The viscous torsional vibration damper according to claim 15, wherein at least one of the radially outer and radially inner cooling channels are oriented at an angle of slope β≦30° with respect to their radial lines R.

25. The viscous torsional vibration damper according to claim 15, wherein the cooling channels are situated on different radial lines R.

26. The viscous torsional vibration damper according to claim 15, wherein the radially inner cooling channels are radially spaced with respect to the radially outer cooling channels.

27. The viscous torsional vibration damper according to claim 25, wherein the radially inner cooling channels are radially spaced with respect to the radially outer cooling channels.

28. The viscous torsional vibration damper according to claim 26, wherein the radial spacing of the cooling channels amounts to between 20% and 100% of the length l of the cooling channels.

29. The viscous torsional vibration damper according to claim 15, wherein the cooling channels with open ends on the radial side are formed in an arched manner from a plane of their circular sheet metal blank.

30. The viscous torsional vibration damper according to claim 15, wherein the cross-section of the cooling channels is one of rectangular, sinusoidal and circular.

31. A viscous torsional vibration damper, comprising:
an annular damper housing, which surrounds a working chamber configured to receive a fly wheel and to be filled with a viscous damping medium;
a fan plate formed on at least one of two faces of the viscous torsional vibration damper, the fan plate having radially inner and radially outer cooling channels arranged thereon in at least two concentric graduated circles, the radially inner cooling channels having different geometrical dimensions than the radially outer cooling channels.

32. The viscous torsional vibration damper according to claim 31, wherein a ratio cₐ between a radial length l and a width b of the radially outer cooling channels is greater than the ratio cᵢ of the radially inner cooling channels.

33. The viscous torsional vibration damper according to claim 32, wherein the ratios cₐ, cᵢ are between 3.5 and 1.

34. The viscous torsional vibration damper according to claim 31, wherein a cross-sectional surface Qₐ of the radially outer cooling channels is smaller than a cross-sectional surface Qᵢ of the radially inner cooling channels.

35. The viscous torsional vibration damper according to claim 32, wherein the radially inner cooling channels are wider than the radially outer cooling channels.

36. The viscous torsional vibration damper according to claim 31, wherein an angular distance αₐ between adjacent radially outer cooling channels is smaller than an angular distance αᵢ of the radially inner cooling channels.

37. A heat transfer apparatus for use with a viscous torsional vibration damper, comprising:
a fan plate operatively configured to be arranged on at least one of two face surfaces of the torsional vibration damper when in use;
wherein the fan plate includes radially inner and radially outer arranged cooling channels, the radially inner and radially outer arranged cooling channels forming two concentric graduated circles on the fan plate; and
wherein the radially inner cooling channels have different geometrically dimensions than the radially outer cooling channels.

38. The viscous torsional vibration damper according to claim 374, wherein a ratio cₐ between a radial length l and a width b of the radially outer cooling channels is greater than a ratio cᵢ of the radially inner cooling channels.

39. The viscous torsional vibration damper according to claim 38, wherein the ratios cₐ, cᵢ are between 3.5 and 1.

40. The viscous torsional vibration damper according to claim 37, wherein a cross-sectional surface Qₐ of the radially outer cooling channels is smaller than a cross-sectional surface Qᵢ of the radially inner cooling channels.

41. The viscous torsional vibration damper according to claim 37, wherein the radially inner cooling channels are wider than the radially outer cooling channels.

42. The viscous torsional vibration damper according to claim 37, wherein an angular distance αₐ between adjacent radially outer cooling channels is smaller than an angular distance aᵢ of the radially inner cooling channels.
